(19) United States
(12) Patent Application Publication
(10) Pub. No.: US 2004/0193591 A1
(43) Pub. Date: Sep. 30, 2004

(54) Searching content information based on standardized categories and selectable categorizers

(76) Inventor: Robert William Winter, Azusa, CA (US)

Correspondence Address: CHRISTIE, PARKER & HALE, LLP, PO BOX 7068, PASADENA, CA, 91109-7068, US

(21) Appl. No.: 10/805,888

(22) Filed: Mar. 22, 2004

Related U.S. Application Data
(60) Provisional application No. 60/457,909, filed on Mar. 27, 2003.

(51) Int. Cl. G06F 7/00

(52) U.S. Cl. 707/3

(57) ABSTRACT

In one embodiment, the present invention is directed to a method and system for identifying content in a computer network. The method and system include the capability of selecting one or more predetermined categories stored in a database and categorizing a number of items corresponding to one or more of the predetermined categories, by a number of categorizers, respectively. selecting a category from the plurality of predetermined categories; selecting a categorizer from the plurality of categorizers; and initiating a search for one or more items in the computer network corresponding to the selected category and the selected categorizer.

In one embodiment, results of the search may be displayed on a display and the results may be ordered based on a user selectable order.

### CROSS-REFERENCE TO RELATED APPLICATION(S)

This Patent Application claims the benefit of the filing date of U.S. Provisional Patent Application Serial No. 60/457,909, filed Mar. 27, 2003 and entitled “SEARCHING CONTENT INFORMATION BASED ON STANDARDIZED CATEGORIES AND SELECTABLE CATEGORIZERS,” the entire content of which is hereby expressly incorporated by reference.

### FIELD OF THE INVENTION

The present invention relates to a computer system and method for identifying material on a computer network. More specifically, the invention relates to searching content information based on standardized categories and selectable categorizers.

### BACKGROUND OF THE INVENTION

The Internet has been popularized by the rapid proliferation of the World Wide Web (WWW or Web). The Web links together a variety of computers around the world and facilitates access to a tremendous variety of topics in a non-sequential web of associations that permits a user to browse from one topic to another, regardless of the format or the order of the topics. Users access and browse the Web using a web browser that generally resides and is executed on the user's computer. Commercially available web browsers such as Netscape's Navigator™ and Microsoft Internet Explorer™ are very common and accessible by personal computer (PC) users.

The Internet functions based on a client/server model. In this model, a client computer communicates with a server computer on which information resides, and the client computer depends on the server to deliver requested information and services. These services may involve searching for information and sending it back to the client, such as when a database on the Web is queried. Other examples of these services are the delivery of information and web pages through a web site, and the processing of incoming and outgoing email. Typically, the client is a user PC (or other web devices) employing a browser to connect to and search the servers. The servers (also known as hosts) are usually more powerful computers that house the data and databases. The client/server model enables the Web to be conceived of as acting like a limitless file storage medium distributed among thousands of host computers, all of which are accessible by any individual PC user.

A popular way of finding information on the Internet is to use search engines, also known as search tools and sometimes called Web crawlers or spiders. Search engines are essentially tools to search massive databases that one accessible via the Internet. Search engines typically don't present information in a hierarchical fashion. Instead, one searches through them similar to a database, by typing keywords that describe the desired information.

However, search engines' ability to assess electronic content is limited by the fact that they are merely software programs, inherently lacking the subtlety and flexibility of human judgment. This restricts a search engine's ability to determine what a web page is actually about. For example, a search engine scanning Jonathan Swift's “A Modest Proposal,” with its deliberately outrageous plan for raising Irish children as a food crop to be sold to English consumers, might conclude that the essay is about economics, agriculture, or nutrition, but would be inherently unable to recognize the piece as a satirical work of Irish nationalism.

Because the ability to recognize aesthetic merit requires subtle human judgment, search engines are inherently incapable of identifying a good poem, a good song, or a good painting.

The shortcomings of the search engines also persist beyond the arts, where the subtleties of human judgment are required to identify sound medical advice, valid technical information, or insightful social and political commentary. Regardless of the type of content sought, quality is a characteristic that requires human judgment to identify.

With more and more content becoming available on the Internet, and search engines returning thousands upon thousands of results for each search, it is no longer enough simply to identify the web pages that are about a given subject. What users want to see are the web pages on that subject that are of high quality.

Certain attempts that have been made to date to interject human judgment-based quality evaluation into the process of helping users find electronic content. For the most part, these have taken the form of directories. In a directory system, human editors are assigned responsibility for keeping up to date on what is noteworthy on the Internet in specific subject areas. When users go to a directory service, every link they see is to a web page that has been specifically recommended in this manner. Major endeavors to categorize what is on the Internet using this technique include the volunteer-based Open Directory Project, whose work is available at www.dmoz.com, as well as the employee- and contractor-based efforts of the original Yahoo!® directory service and About.com™.

But with directory services, the number of individuals evaluating online content in any given area is always small. Most often it is limited to just one person. The user is also given no choice in whose evaluations he prefers to go by. Unfortunately, no single person or small group can effectively represent the tastes and quality standards of all users.

In order to effectively to put diverse users in touch with the content that will meet their varied tastes and standards of quality, multiple and divergent evaluations of the same piece of content are needed. The user must also be able to pick the evaluator whose tastes he trusts.

Therefore, there is a need for a more effective system and method for searching content information in a large network of databases.

### SUMMARY OF THE INVENTION

In one embodiment, the present invention is directed to a method and system for identifying content in a computer network. The method and system include the capability of selecting a plurality of predetermined categories stored in a database; categorizing a plurality of items corresponding to one or more of the plurality of predetermined categories, by a plurality of categorizers, respectively; selecting a category from the plurality of predetermined categories; selecting a categorizer from the plurality of categorizers; and initiating a search for one or more items in the computer network corresponding to the selected category and the selected categorizer. In one embodiment, results of the search may be displayed on a display and the results may be ordered based on a user selectable order.

In one embodiment, the present invention is directed to a method and system for categorizing an item to be searched by a user in a computer network including accessing a web site by an authorized categorizer; identifying the item to be categorized; selecting a category from a plurality of predetermined categories stored in a database accessible by the web site; applying the selected category to the identified item; and storing the identified item and the applied category in the database.

In one embodiment, an authorized user needs to sign up on a web site. The user is then capable of selecting a category from a plurality of predetermined categories; selecting a categorizer from a plurality of categorizers; and initiating a search for an item in the computer network corresponding to the selected category and the selected categorizer.

### BRIEF DESCRIPTION OF THE DRAWINGS

The objects, advantages and features of this invention will become more apparent from a consideration of the following detailed description and the drawings, in which:

FIG. 1 is a block diagram of a typical Internet client server environment;

FIG. 2 is an exemplary process flow for a Categorize Material Function executed by one or more computers, according to one embodiment of the present invention;

FIG. 3 is an exemplary process flow for a Find Material Function, according to one embodiment of the present invention;

FIG. 4 is an exemplary data model diagram depicting the structure of the information used by the system, according to one embodiment of the present invention;

FIG. 5 is an exemplary data model diagram depicting the structure of the information used by the system, according to one embodiment of the present invention;

FIG. 6 is an exemplary screen depicting a Find Material Screen, according to one embodiment of the present invention;

FIG. 7 is an exemplary Search Results sub-screen, according to one embodiment of the present invention;

FIG. 8 is an exemplary screen for Content Categorization Screen, according to one embodiment of the present invention;

FIG. 9 depicts the bottom half of the exemplary Content Categorization Screen of FIG. 8; and

FIG. 10 is an exemplary Review Categorizations Sub-screen.

### DETAILED DESCRIPTION

The method and system of the present invention provide means for users to find material on a computer network, such as the Internet, based on standardized categories being applied to particular items by recognizable persons and organizations. Users are able to select a categorizer as well as a category. For example, a user can select Romantic Music from a Graphical User Interface (GUI), such as a displayed list, and select from another GUI a particular music critic (a categorizer) who has applied the category Romantic Music to one or more items. The user is then presented with a search result set limited to items that meet both criteria.

One embodiment of the present invention involves the use of the Internet as a means for signing up users and categorizers, for processing their transactions and disseminating information based on categories and categorizers.

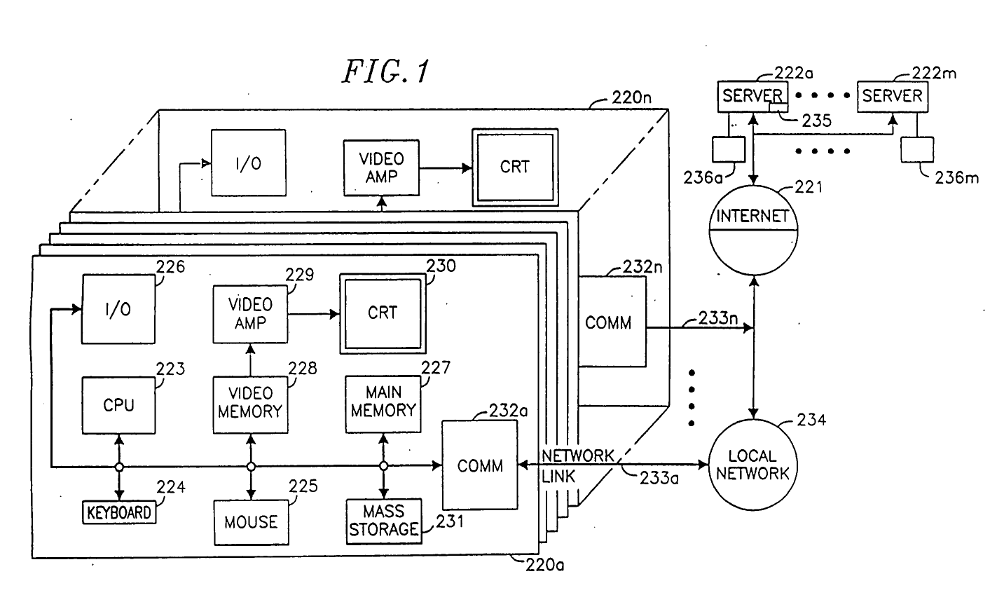

FIG. 1 shows a block diagram of a typical Internet client server environment used by the users and categorizers according to one embodiment of the present invention. PCs 220a-220n, used by users and categorizers, are connected to the Internet 221 through the communication links 233a-233n. Optionally, a local network 234 may serve as the connection between some of the PCs 220a-220n, such as the PC 220a and the Internet 221. Servers 222a-222m are also connected to the Internet 221 through respective communication links. Servers 222a-222m include information and databases accessible by PCs 220a-220n. In one embodiment of the present invention a database resides on at least one of the servers 222a-222m and are accessible by the processor, aggregators, participants, and merchants using one or more of the PCs 220a-220n.

In one embodiment of the present invention, each of the PCs 220a-220n typically includes a central processing unit (CPU) 223 for processing and managing data, and a keyboard 224 and a mouse 225 for inputting data. Also included in a typical PC are a main memory 227, such as a Random Access Memory (RAM), a video memory 228 for storing image data, and a mass storage device 231 such as a hard disk for storing data and programs. Video data from the video memory 228 is displayed on the CRT 230 by the video amplifier 229 under the control of the CPU 223. A communication device 232, such as a modem, provides access to the Internet 221. Optionally, one or more of PCs 220a-220n may be connected to a local network 234. An Input/Output (I/O) device 226 reads data from various data sources and outputs data to various data destinations.

Servers (hosts) 222a-222m are also computers and typically have architecture similar to the architecture of PCs 220n-220n. Generally, servers differ from the PCs in that servers can handle multiple telecommunication connections at one time. Usually, servers have more storage and memory capability, and higher-speed processors. Some server (host) systems may actually be several computers linked together, with each handling incoming web page requests. In one embodiment, each server 222a-222m has a storage medium 236a-236m, such as a hard disk, a CD drive or a DVD for loading computer software. When software such as that responsible for executing some of the processes in FIGS. 1-4 is loaded on the server 222a, off-the-shelf web management software or load-balancing software may distribute the different modules of the software to different servers 222a-222m. Therefore, in one embodiment, the computer program responsible for executing the present invention resides on one or more servers.

An exemplary web site location 235 is shown on server 222a in FIG. 1. The web site 235 is the user interface (UI) for accessing the database. The web site 235 has a unique address that is used by the users to access server 222a (in this example) and the web site location on the server 222a. The computer software for executing the processes of the present invention may also reside within the web site 235. In one embodiment, servers 222a-222m are protected by a firewall. The firewall permits a client to communicate with a server system, only if the information packet transmitted by the client system complies with a security policy set by the server system. Thus, the firewall protects the system from unauthorized users on the Internet.

The “Says who?” factor of being able to specify a categorizer up front, according to the present invention, enables users to limit their searches to material that has been categorized by persons and organizations they find credible. This process effectively eliminates the “spam” and clutter that currently bog down search engines. Meanwhile, the standardized categories eliminate much of the guesswork and sloppiness inherent in existing techniques, such as word matching. Examples of standardized categories include music, movies, books, politics, web pages, cars, consumer products, “satire on current events”, “California Plein Air”, “Ford, Mustang, Cobra”, “osteomyelitis: symptoms and diagnosis”, etc.

Using the present invention, categorizers have various incentives to maintain accuracy and completeness in their work. In some cases, direct monetary payments are made to categorizers, based on the number of users who have selected an item through their categorizations. In other cases, self-categorizers find sufficient incentive in the increased traffic that their participation in the service enables them to draw to their own web sites. Yet another type of incentive involves making positioning in search result sets as well as categorizer lists reflect the popularity and reliability of the categorizers and pages. High reliability is indicated by a relatively low percentage of users coming back to the search results page within a short time after having selected an item. A combination of two or more above-mentioned incentive schemes maybe also used.

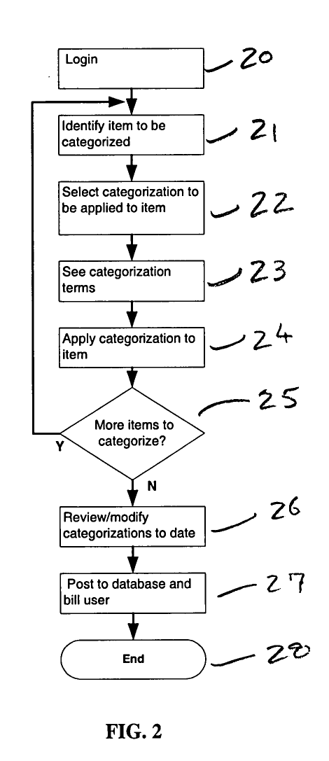

FIG. 2 is an exemplary process flow for a Categorize Material Function executed by one or more of PCS 220n-220n and servers 222a-222m, according to one embodiment of the present invention. Block 20 shows a login step. In this step, the categorizer is identified, and is tied to a credit card or other payment method, etc., in order to effectively link a categorization to a categorizer.

The item to be categorized is identified in block 21. A categorization links a particular item, which will become known to the invention via its internal database (if it is not already known there) to a particular category, which is also stored in the internal database. In this step, the appropriate database record for the item to be categorized is either identified or created.

One way of performing this step is via an online screen, where the user enters the URL of a web page to be categorized. For confirmation and validation purposes, an image of the page may appear in a portion of the categorization screen.

However, not every item to be categorized needs to have its own URL. For example, a particular cut of music might not have a unique web page devoted to it, yet it still needs to be uniquely identified if it is to be categorized. In this case, a different unique identifier, such as the one used by the music vendor, is employed. Also, not every categorization is performed via an online screen. Magazines, for example, will often prefer to categorize their own online articles via batch files and processes.

The categorization to be applied to item is selected in block 22. In an online categorization, the categorizer selects the category from the same GUI or other screen object that is offered to users who search for material on the service. In batch categorizations, such as those performed for magazines, online music vendors, or merchants with web sites, selecting the categorization is a matter of specifying the unique identifier of the appropriate category record within the internal database.

In one embodiment, at least one of the predetermined categories relates to security and intelligence content, whether in the form of text, sound, still or moving images, or other media. This content may reside on the Internet, on one or more internal Intranets, or within purely internal servers and networks. Other predetermined categories may relate to business intelligence content, whether in the form of text, sound, still or moving images, or other media.

Items may include products sold and/or advertised over the Internet, such as arts and crafts, wine and cheese, microbrewery beers, and other products. Items may also include services advertised over the Internet, such as plumbing and air conditioning, auto repair, haircutting, legal or medical services, etc.

The categorization terms are displayed in block 23. Before making a categorization, the categorizers may want to know how much it will cost, as well as what financial incentive, if any, will be paid to them when users select an item via their categorization. However, not all categorizations are incentivized. For example, magazines may post categorizations of their online articles simply to boost traffic and advertising revenues, as well as to introduce the magazines to potential new subscribers. Displaying categorization terms is an optional step that the categorizer may choose to omit.

In block 24, selected categorization is applied to the item. In this step, the categorization is noted but not permanently applied to the database. In one embodiment, the categorizer simply keeps on making additional categorizations until she has no more categorizations to make, as depicted by block 25. In batch versions of the function, the absence of more items to be categorized is indicated by an end-of-file condition.

As shown in block 26, categorizations may be reviewed and/or modified to date. This step enables the categorizer to see all his proposed categorizations to date, along with the costs associated with making them. If the categorizer needs to stretch his budget, he may eliminate some proposed categorizations that are less important to him, in order to be able to make others that are more important to him. In certain cases where the categorizer has appropriate rights, she may also change the name or description of an item. This step is optional, and may be undertaken at any time before Step 27.

Categorizations are posted to database and the categorizer is billed in block 27. This is the stage at which categorizations become part of the service's retained database. The categorizer is charged for his categorizations, to deter frivolous or “spam” categorizations, as well as to provide a revenue stream to support the service. Payment is typically performed via credit card, although other payment methods may also be used, particularly in the case of corporate categorizers such as online music vendors, magazines with online editions, and retailers.

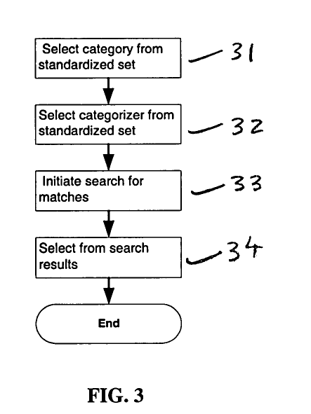

FIG. 3 is an exemplary process flow for a Find Material Function, according to one embodiment of the present invention. A category is selected from standardized set in block 31. Selecting a category from a standardized set eliminates the “type and guess” problem common to existing search functions.

For example, suppose a supplier, such as Acme Electronics Corporation produces a video cell phone with model number A1234 called the Communicator II. Under the existing “type and guess” method, a user searching for information pertaining to this product does not know whether to type “cell phones,” “video cell phones,” “cell phones with video,” “Acme A1234,” “Acme Electronics A1234,” “Acme Communicator II,” or some other combination of letters and numbers. The possibilities are enormous, and no matter which combination the user tries, he is virtually guaranteed to miss pages where the product is described in a slightly different manner. This problem disappears when those who categorize material and those who search for it both select from the same standardized list of categories.

A partial typing function eliminates the need for the user to know where to find a given category within the service's overall category structure. For example, to find material about osteoporosis, the user can type in “ost,” and be presented with a set of standardized categories containing those characters-including osteomyelitis, osteopathy, and ostriches as well as osteoporosis. The user then selects the desired category from the resulting set.

Presented upfront with each category in the selection set is a count of how many items are categorized by category. This allows the user to know immediately whether to narrow or broaden his search. A “More Specific” function enables the user to narrow a search-for example, from “osteoporosis” to “osteoporosis symptoms” or “osteoporosis treatment.” A “More General” function enables the user to broaden the search, for example, to “bone diseases” or “diseases involving dietary shortages.”

More than one category can be specified to be matched, and the user can specify the manner in which multiple categories compound. For example, “meet all of these criteria” and “meet at least one of these other criteria” can be specified in the GUI. A “not” capability is also offered.

As shown in block 32, a categorizer is selected from the standardized set. Selecting a categorizer enables the user to specify whose judgment he trusts. For example, just seeing that a web page has been categorized as “responsibly researched” may not be enough for the user. What if this categorization has been made by the Society of UFO Abduction Survivors? By specifying a more trusted entity like the Columbia University School of Journalism, the user can eliminate material of dubious appeal to him. Eliminating undesirable material also effectively increases the supply of genuinely desirable material the user sees within her search results.

A synchronization feature matches categorizers to categories. If for example, the user selects the category of “osteoporosis,” the standardized set of categorizers shows only those who have actually assigned material to this category.

Once the user has selected a categorizer, the set of categories displayed is restricted to ones that the categorizer has actually used. For instance, if a rock music critic has not categorized anything in the field of “antique china,” there is no reason to display this category for him. The user can go back and forth at will between steps 31 and 32. There is no requirement for these to be performed in any particular order, or for either step to be performed only once.

As depicted in block 33, the user can initiate a search for matches. When the user indicates that she is finished entering selection criteria, the service consults its internal database to find material matching what has been specified. In one embodiment, the sequencing of the search results is based on a page's popularity as well the popularity of its home page, plus the order in which categorizers have ranked each page relative to other pages they have categorized in the same manner. Other sequencing and display priorities are also possible. In one embodiment, the display sequencing can be set by the user.

As illustrated in block 34, an item is selected from search results. Selecting an item takes the user to it. For example, if the user selects a description of an article in the online edition of The Atlantic Monthly, that article is displayed on the screen.

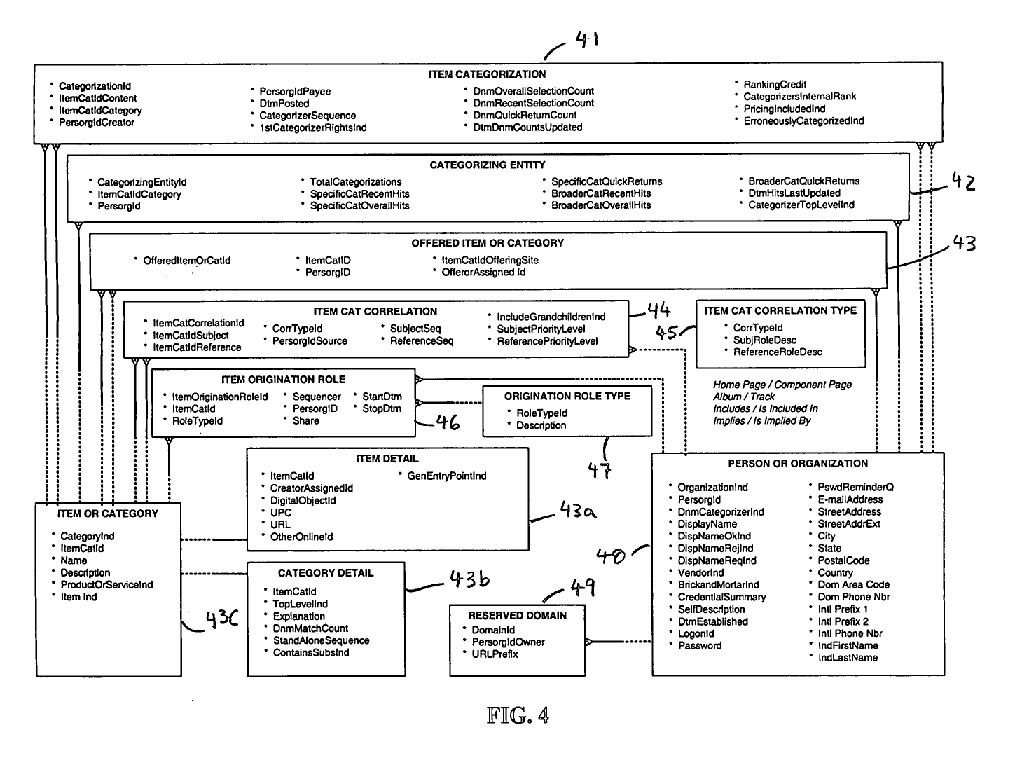

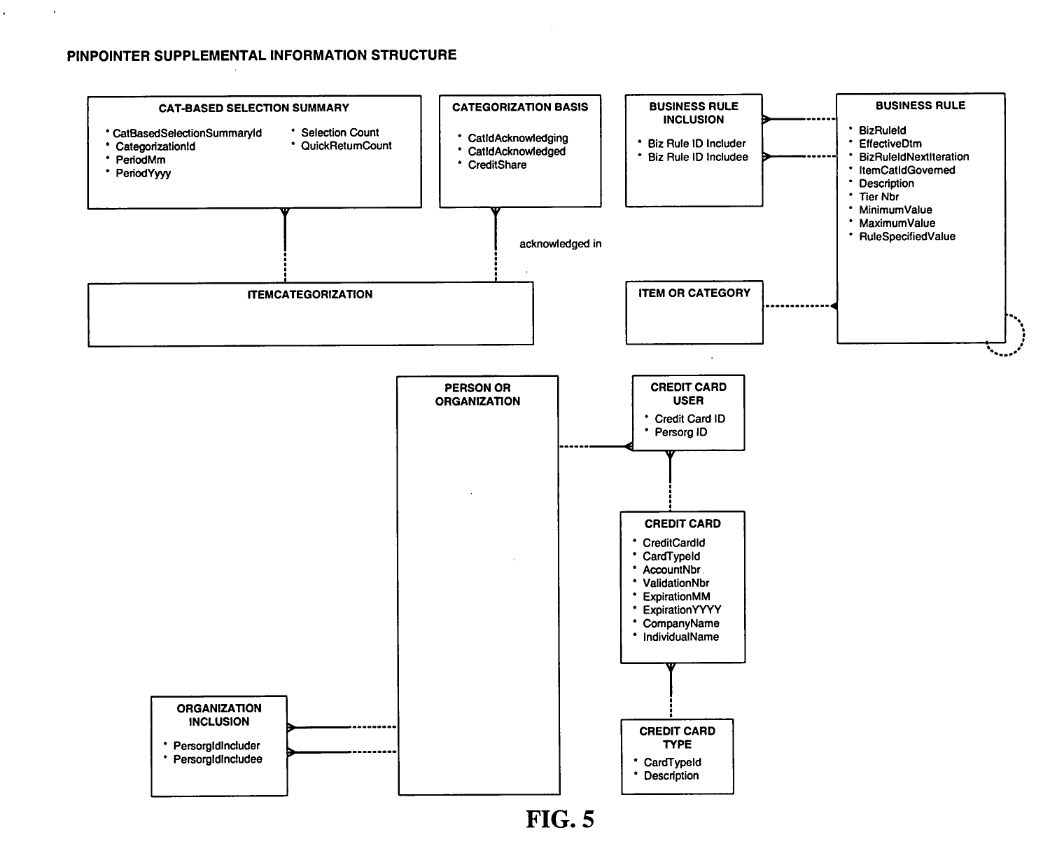

FIGS. 4 and 5 are exemplary data model diagrams depicting the structure of the information used by the system, according to one embodiment of the present invention. The data model includes tables containing information about the items that are categorized, the categories used, and the persons or organizations who make the categorizations. By using only categories contained in rigorous, standardized indexed tables rather than freeform text, the system ensures that a user can always find every item to which a given category applies.

The tables are represented as boxes, and their interrelationships are represented by the lines connecting them. For example, in FIGS. 4 and 5, an Item Origination Role 46 links a Person or Organization 48 and an Origination Role Type 47 to an Item or Category 43C. When real data is loaded into these tables, an Item Origination Role might show the Person or Organization, e.g., “The Beatles” in the Origination Role Type of “Primary Artist” for the Item or Category “A Hard Day's Night.”

Nuances in connecting lines reflect the nature of a relationship. As shown in FIGS. 4 and 5, a three-pronged line ending called a “crow's foot” indicates that there can be many of the entity it touches, while the absence of the crow's foot at a line ending means the relationship allows only one of the entity it touches. For example, an Item or Category can have many Item Origination Roles (e.g., “A Hard Day's Night” might have an additional Item Origination Role showing the Person or Organization “Ringo Starr” in the role of “Percussionist”), but each Item Origination Role can pertain to one and only one Item or Category.

In this embodiment, whether a line is solid or dotted indicates whether the relationship is mandatory or optional from the standpoint of the entity it touches. Thus, “A Hard Day's Night” can exist as an Item or Category without having any associated Item Origination Roles, but an Item Origination Role cannot exist unless it is linked to some specific Item or Category.

In this exemplary data model, both items and categories are represented in the same table. This scheme enables “A Hard Day's Night” to be an end item in its own right, to people who are shopping for music—and at the same time, a subject or category, to people who are looking for reviews and other articles about “A Hard Day's Night.” The Item Categorization table is what conclusively links an item to a crisply-defined category, as well as to the person or organization making the categorization. More detailed information about each data table and its associated fields is available in a Data Dictionary enclosed as Appendix A with this disclosure.

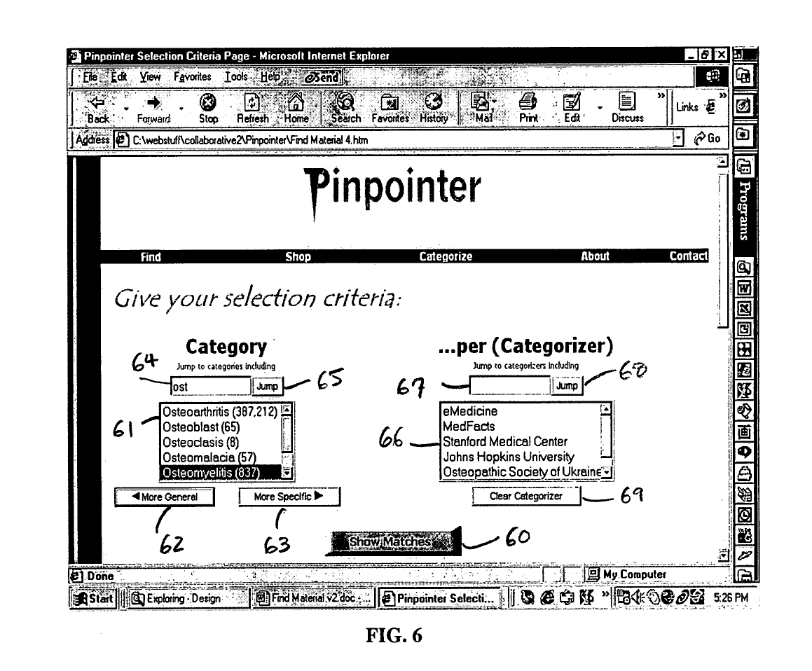

An exemplary way that users tell the system the kind of material they're looking for is shown in FIG. 6, as a Find Material Screen. Users can pick a category first, or pick a categorizer first. They might pick a category without specifying a categorizer, or even choose a categorizer without specifying a category.

After the users have input their criteria, they select the “Show Matches” button 60, and are then presented with the Search Results Panel including a hyperlinked list of sites matching their criteria.

Values 61 are a concatenation of ItemorCategory.Description and CategoryDetail.DnmMatchCount. Initially only those ItemsorCategories whose CategoryDetail.TopLevelInd=1 are displayed. Thereafter, contents per user inputs on Items 62 through 68 can be changed. In one embodiment, any ItemorCategory whose CategoryInd is not=1 is not shown in this screen, no matter what inputs the user gives.

The entries in this screen are ordered by the StandAloneSequence shown in their corresponding CategoryDetail, unless the user repopulates it via partial typing-in which case, they are ordered alphabetically.

When a user selects an ItemorCategory.Description, the row is highlighted, and also Item 66 is populated with the DisplayNames of only those PersonsorOrganizations who are CategorizingEntities for the ItemorCategory in question. That is, it is ensured that CategorizingEntity.ItemCatID matches the ItemCatIDCategory of the user's selection.

As a practical matter, this may mean that any access to the database for ItemsorCategories should actually populate internal arrays or data structures representing not only the appropriate set of ItemsorCategories, but also all associated CategorizingEntities and Personsororganizations. However, this pre-population of internal data structures may be avoided if the net delay to the user of making another access to the database after a Category is selected is only slight.

When item 62 is selected, Item 61 is re-populated with parents of the category selected and its synonyms, via the following logic:

Identify synonyms as all ItemsorCategories whose ItemCatCorrelation. ItemCatIDSubject or ItemCatCorrelation.ItemCatIDReference=the ItemCatID of the ItemorCategory that the user has selected from Item 1, and whose corresponding ItemCorrelationType. SubjRoleDesc or ItemCorrelationType.ReferenceRoleDesc is “Synonym for.”

For all synonyms as well as for the user-selected category, identify parents as those ItemsorCategories whose ItemCatCorrelation.ItemCatIDReference=the ItemCatID of the ItemorCategory that the user has selected from Item 1, and whose corresponding ItemCorrelationType. ReferenceRoleDesc is “Included In.” The results are then ordered by ItemCatCorrelation.SubjectSeq.

If no Categorizing Entity has been specified in Item 66, the results are ordered by ItemCatCorrelation.SubjectSeq.

If a single categorizer has been selected, the system additionally ensures that there is a CategorizingEntity reflecting that PersonorOrganization's PersorgID for every ItemorCategory being considered for display. Although this exemplary screen allows only a single categorizer to be specified, multiple categorizers can be selected using a similar screen including a complex algorithm to sequence the values displayed in Item 61.

Error Condition A: If button 62 is selected when the user has not selected a value from Item 61, the error message, “Please select the content category to see more general values for” is displayed with an OK button.

Error Condition B: If button 62 is selected when no ItemCatCorrelations whose corresponding ItemCorrelationType.SubjRoleDesc is “Is included in” are found showing the selected ItemorCategory as ItemCatIDReference, display the error message “No more general levels exist” with an OK button.

When item 63 is selected, Item 61 is repopulated with children of the category selected and its synonyms, via the following logic:

Identify synonyms as all ItemsorCategories whose ItemCatCorrelation.ItemCatIDSubject or ItemCatCorrelation.ItemCatIDReference=the ItemCatID of the ItemorCategory that the user has selected from Item 1, and whose corresponding ItemCorrelationType.SubjRoleDesc or ItemCorrelationType.ReferenceRoleDesc is “Synonym for.”

For all synonyms as well as for the user-selected category, identify children as those ItemsorCategories whose ItemCatCorrelation.ItemCatIDSubject=the ItemCatID of the ItemorCategory that the user has selected from Item 61, and whose corresponding ItemCorrelationType.ReferenceRoleDesc is “Is Include In.” Order results by ItemCatCorrelation.ReferenceSeq.

Error Condition A: If button 63 is selected when the user has not selected a value from Item 1, display the error message, “Please select the content category to see more specific values for” with an OK button.

Error Condition B: If button 63 is selected when no ItemCatCorrelations whose corresponding ItemCorrelationType.SubjRoleDesc is “Includes” are found to show the selected ItemorCategory.ItemCatID as ItemCatIDSubject, display the error message “No more specific levels exist” with an OK button.

Area 64 enables the user to bypass navigating through successive menu levels by partially typing a value here, then selecting Item 65 to display any matches to what has been typed. Trailing wildcards are assumed, i.e., in the example shown, just typing in “ost,” without any special character as suffix, is enough to bring up “osteoblast,” “osteoclasis,” and all the other values shown.

When button 65 is selected, Item 61 is re-populated with only those ItemsorCategories whose Descriptions begin with the characters that have been typed into Item 64. The results are then ordered alphabetically.

Error Condition A: If button 65 is selected when fewer than three characters have been entered into Item 64, display the error message “Please enter at least the first three characters of the value you want to match” with an OK button.

Area 66 is Populated with appropriate PersonsorOrganizations' DisplayNames. When the screen first appears, no values should be displayed here. Area 66 is populated subsequently based on the selection the user makes in Item 61, by finding all CategorizingEntities whose Category IDs match that of the specified ItemorCategory. The results are sequenced via the complex logic described in the General Notes section that follows these Field-Specific Notes.

Once the user has selected an item here and highlighted it, what appears in Item 61 is restricted to the Descriptions of only those ItemsorCategories that are linked to the selected PersonorOrganization as a CategorizingEntity. This restriction stays in place no matter how the user alters the contents of Item 61, unless the user selects the Clear Categorizer button (Item 69).

Additional processing depends on whether the user has already selected a category. If the user has already selected a category, Item 61 is immediately repopulated with just the category that has been selected, and the display continues to show it as highlighted. If the user has not yet selected a category, item 61 is immediately repopulated to show just the highest-level categories that the categorizer has used, which are identified as cases where CategorizingEntity has its CategorizerTopLevelInd set to 1. The results are sorted alphabetically by ItemorCategory.Description.

As a practical matter, values for Categorizer will usually be obtained from an internal data structure or array populated as described in the description for Item 61. However, if the user bypasses Item 61 and goes straight to this item, then the array is populated via the database. In this event, the internal data structure or array items corresponding to CategorizingEntity and ItemorCategory are also be populated with whatever values are shown as linked-i.e., via joins on PersorgID and ItemCatID.

Area 67 enables the user to bypass scrolling through names via partial typing in this area. As with Category, trailing wildcards are assumed.

When Item 68 is selected, Item 66 is re-populated with only those Personsororganizations whose DisplayNames begin with the characters that have been typed into Area 67. The results are ordered alphabetically.

Error Condition A: If Item 68 is selected when fewer than three characters have been entered into Area 67, the error message “Please enter at least the first three characters of the value you want to match” is displayed with an OK button.

When Item 69 is selected, the previously highlighted value in Item 66, is de-highlighted and the logical restriction that what is displayed in Item 61 reflect only ItemsorCategories that are linked to the previously specified PersonorOrganization via a CategorizingEntity is removed.

When item 60 is selected, the Search Results Sub-Screen is generated and displayed.

In one embodiment, the presentation order of categorizing entities reflects the following six factors, each of which is a field within CategorizingEntity:

(a) Categorizer's overall popularity within a user-specified subject area (SpecificCatOverallHits)

(b) Categorizer's recent popularity within a user-specified subject area (SpecificCatRecentHits)

(c) Categorizer's overall popularity within a broader subject area (BroaderCatOverallHits)

(d) Categorizer's recent popularity within a broader subject area (BroaderCatRecentHits)

(e) Categorizer's reliability within a user-specified subject area (SpecificCatQuickReturns)

(f) Categorizer's reliability within a broader

subject area (BroaderCatQuickReturns)

Values for each of the six factors are found within the CategorizingEntity record linking a given PersonorOrganization to the ItemorCategory the user has specified. Popularity is equivalent to hits; reliability is the percentage of overall hits that are quick returns, where the lower the percentage, the higher the reliability.

Each of the six factors is multiplied by a weighting factor found in a BusinessRule. The BusinessRule whose Description is “Categorizer Weighting;” is first found, then the component BusinessRules that are included in this one (i.e., those found in BusinessRuleInclusions with its BizRuleID as their BizRuleIDIncluder) are located. The Descriptions of these component BusinessRules contain the following values:

“Overall Popularity Within Specific Category”

“Recent Popularity Within Specific Category”

“Overall Popularity Within Broader Category”

“Recent Popularity Within Broader Category”

“Reliability Within Specific Category”

“Reliability Within Broader Category”

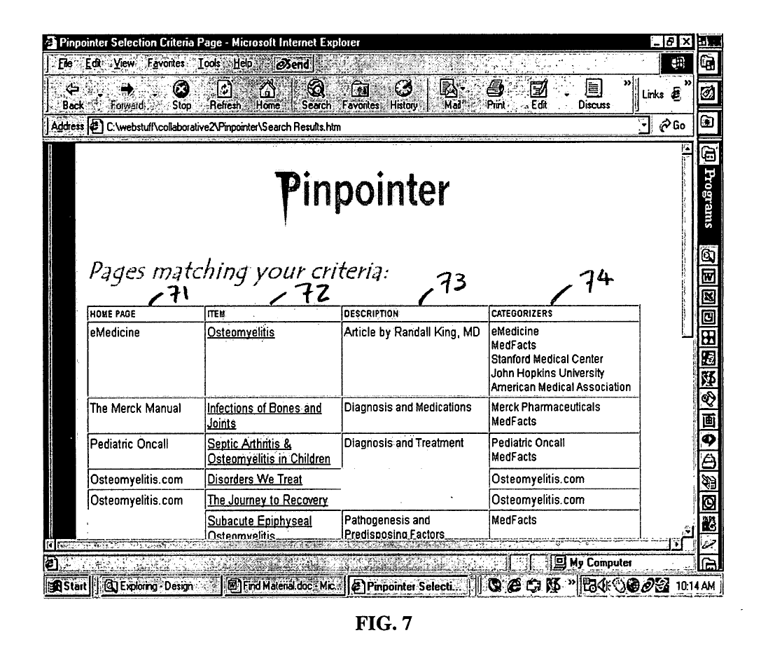

An exemplary Search Results sub-screen is shown in FIG. 7. This screen is dynamic HTML, generated after the user selects the Show Matches button on the Find Material screen.

Area 71 shows Name of the ItemorCategory whose ItemCatID appears in an ItemCatCorrelation.ItemCatIDsubject, and whose corresponding ItemCorrelationType. SubjRoleDesc is “Home Page,” for a page returned as a search result. (May be blank.)

Area 72 shows Name of an ItemorCategory returned in the search, with hyperlink to its URL. Before the page is brought up, selection counts are updated as described in General Notes below.

Area 73 illustrates Description of an ItemorCategory returned in the search. (May be blank.)

DisplayNames of all PersonsorOrganizations with ItemCategorizations fitting the user's selection criteria are shown, by DTMPosted. The results are limited to 5. Hyperlinks are included so that when selected, they bring up a panel showing the SelfDescription of the PersonorOrganization making the categorization.

The order in which search results are presented is of significance, since utility to users depends on having the best matches to their criteria appear at the top of the list. In one embodiment, four factors are considered in the sequencing process:

(a) The popularity of a given page.

(b) The popularity of a given page's home page.

(c) Categorizers' internal rankings of the page, weighted to reflect the popularity of each categorizer.

(d) As a tie-breaker, the DTMPosted for each page, with preference given to the earliest poster.

The system starts by finding the BusinessRule whose Description is “Search Results Sequencing”. One of this rule's components is “Page Popularity,” whose components in turn are “Overall Hits,” “Recent Hits,” and “Quick Returns”. The RuleSpecifiedFactor assigned to each contains a weighting factor. This weighting factor is multiplied by the ItemCategorization's DnmOverallSelectionCount, DnmRecentSelectionCount, and DnmQuickReturnCount (respectively), and added to an overall sum.

Another component is “Home Page Popularity,” whose components are the same as for “Page Popularity.”

The third major component is “Rankings by Categorizers,” which is computed as follows:

Multiply ItemCategorization.RankingCredit by “CategorizerWeighting” (the latter value has already been calculated to sequence the categorizers in the main screen).

Add the result to a total representing a cumulative weighted average of the positions all the various categorizers have assigned the ItemorCategory.

Note that the appropriate weighting factor for each of the three major components described above is shown in its BusinessRule.RuleSpecifiedValue See Appendix A). In one embodiment, the entire sequencing of the search results is programmable by the user.

The system provides rewards to the sites that the users choose most frequently, including favorable positioning within search results sets, and in some cases, cash incentive payments. It is therefore necessary to keep an accurate running tab of how many times users select a given page, under what content categories, and based on the recommendations of what persons or organizations.

Sometimes, the credit for a user selection is shared. For example, if the user has specified in his search criteria that either of two categorizing entities is acceptable, and both of these entities have categorized a content item in the specified way, then both entities validly deserve a share of the credit if the user selects that item.

Just as credit can be shared among entities, it can also be shared across content categories, in cases where the user specifies more than one category. Thus, whenever a user selects a content item with two or more content categorizations reflecting multiple user criteria, the credit is split among the categorizations.

In one embodiment, the crediting principle involved is that the sum of all credits for a given user selection must equal 1. In other words, if the user has specified four content categories, then each of these categories must be given equal credit of ¼. Likewise, if three user-specified categorizing entities have made content categorizations within one of the specified four areas, then each of these 1/4 credits must be further split among the three entities, with each getting a 1/12 credit.

In one embodiment, computation of credits proceeds according to the following logic:

(a) Compute the number of credit units due an ItemCategorization=1 divided by the number of ItemsorCategories the user has specified.

(b) Add the result of step (a) to the SelectionCount for the current PeriodMonthYear for the ItemCategorization itself, independent of whoever may have made the categorization(s). (In the database, this is represented as a CategorizationBasedSelectionSummary pointing to the ItemCategorization where PersorgIDCreator is null.)

(c) Compute the credit due each categorizer, by taking the result of step (b) and dividing it by the number of categorizers specified by the user who have actually made the type of categorization the user has indicated. (NOTE: If the user has not specified any CategorizingEntities, then the credit is to be shared equally among all those PersonsorOrganizations who have created ItemCategorizations indicating the user-specified ItemorCategory for the user-selected ItemorCategory.)

(d) Add the result of step (c) to the SelectionCount for the current PeriodMonthYear of the CategorizationBasedSelectionSummary of each ItemCategorization in which the PersorgID of the user-specified entity appears as PersorgIDCreator. (NOTE: To maintain quick screen response time, update of these database counts can take place in an asynchronous mode.) In one embodiment, a number of denormalized summary counts are used in the data model to improve performance, rather than keep the user waiting while the system goes off and makes various tallies and comparisons in real time. These counts are updated in batch mode. They include the following:

Within the ItemCategorization table, the fields DnmOverallSelectionCount, DnmRecentSelectionCount, and DnmQuickReturnCount are updated by tallying the values in the CatBasedSelectionSummary table, as guided by entries in the BusinessRule table to determine which selections to call “recent.”

Within the CategorizingEntity table, SpecificCatRecentHits, SpecificCatOverallHits, SpecificCatQuickReturns, BroaderCatRecentHits, BroaderCatOverallHits, and BroaderCatQuickReturns are updated in a similar manner, only the batch program receives further guidance on what is meant by “broader category” from an additional entry in the BusinessRule table. This entry is a numerical value that tells the batch tallying program how many levels to go up the ItemOrCategory hierarchy, as well as how many levels to go down within their descendants, in making the tallies. Based on the settings in BusinessRule entries, the batch program can evaluate “broader category” to mean just siblings and parents of a given category, or cousins and aunts and uncles, or nieces and nephews in addition to cousins, or second cousins, or third cousins, etc.

Also within the CategorizingEntity table is a field called TotalCategorizations, which the batch programs update to show a count of all ItemCategorizations for the category in question whose PersorgIdCreator matches the PersorgId of the CategorizingEntity in question.

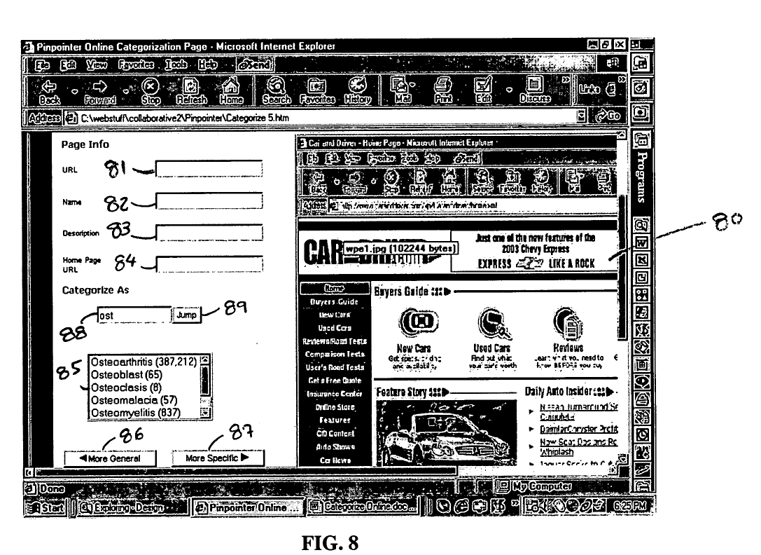

FIG. 8 depicts an example for Content Categorization Screen. The exemplary screen shown is one way users categorize a page online in the system of the present invention. (For magazines with online editions and other high-volume content categorizers, there is also a batch update utilizing a file that the categorizer provides.) Entering this screen requires that the user be registered and logged on to the system.

The categories are specified in a manner virtually identical to the way they are selected in the Find Material screen.

When the user types or pastes a URL in Item 81 and hits Enter, the system first checks to see if an ItemorCategory with CategoryInd=2 exists in the database whose ItemDetail has a matching URL. If so, Items 82 and 83 are populated in a non-updateable manner with the existing ItemorCategory's Name and Description; Item 84 is then populated in a non-updateable manner with the ItemDetail.URL of any ItemorCategory whose ItemCatID appears as the ItemCatIDSubject in an ItemCatCorrelation whose ItemCatIDReference matches that of the selected page, and whose corresponding ItemCorrelationType.SubjRoleDesc is “Home Page.”

If no ItemorCategory is found with an ItemDetail.URL matching what was entered in Item 81, the system determines whether or not the user has update rights to the ItemorCategory to be created, by searching for a match between the beginning characters of the URL that the user has entered and the URLPrefix of a ReservedDomain owned by the PersonorOrganization making the categorization. If the user has this right, the System enables Items 82 and 83 to be updated; otherwise, the Systems goes to the URL in question, and populates Item 82 with the page's Title, and Item 3 with the page's Description (which may be found in a meta tag as well as in a more traditional representation).

Regardless of whether or not a pre-existing ItemorCategory has been found in the database, Item 80, the large display area to the right, is filled with an image or other non-functional view of the contents of the specified web page (i.e., if the user selects a menu item, button, or hyperlink within this display-only area, no action results).

If presented in updateable mode, what the user types in Item 82 will become the Name of an updated or newly created ItemorCategory. If presented in updateable mode, what the user types in Item 83 will become the Description of an updated or newly created ItemorCategory.

When a value is typed or pasted in Item 84, it will remain in place no matter how the user navigates through the pages displayed in Item 80. It will also remain in place through successive categorizations of different pages, until it is specifically removed or changed.

Note that if the user presses Enter after entering a value in this field, the Item 80 display area will show the page in question. Items 81, 82, and 83 will also be populated, in the same manner as if the user had entered the value in Item 81 and pressed Enter. (This is a form of navigation that will be used frequently by magazines.)

Values in Item 85 are a concatenation of ItemorCategory.Description and corresponding CategoryDetail.DnmMatchCount. Initially, only those ItemsorCategories whose CategoryDetail.TopLevelInd=1 are displayed. Thereafter, change contents per user inputs on Items 86, 87, 88, and 89. (NOTE: Any ItemorCategory whose CategoryInd is not=1 is not displayed, no matter what the user does with items 86 through 89.)

When a user selects an ItemorCategory.Description, the row is highlighted and the selection is retained until the user specifically changes it. (For example, the user might want to categorize a number of pages as being about Osteomyelitis. It would be annoying for the user to have to go back and re-select this category after every individual, page-level categorization he makes.)

When Item 86 is selected, Item 85 is re-populated with only those ItemsorCategories with ItemCatCorrelations that are of the ItemCorrelationType whose ReferenceRoleDesc is “Is Included In,” and whose ItemCatIDReference match the ItemCatID of the ItemorCategory that the user has selected from Item 85. The results are ordered by ItemCatCorrelation.ReferenceSeq.

Error Condition A: If button 86 is selected when the user has not selected a value from Item 85, the error message, “Please select the content category to see more general values for” is displayed with an OK button.

Error Condition B: If button 85 is selected when no ItemCorrelations whose corresponding ItemCorrelationType.ReferenceRoleDesc is “Is Included In” the selected ItemorCategory as ItemCatIDReference, display the error message “No more general levels exist” is shown with an OK button.

When Item 87 is selected, Item 85 is re-populated with only those ItemsorCategories with ItemCatCorrelations that are of the ItemCorrelationType whose SubjRoleDesc is “Includes,” and whose ItemCatIDSubject match the ItemCatID of the ItemorCategory that the user has selected from Item 85. The results are ordered by ItemCatCorrelation.SubjectSeq.

Error Condition A: If button 87 is selected when the user has not selected a value from Item 85, the error message, “Please select the content category to see more specific values for” is displayed with an OK button.

Error Condition B: If button 87 is selected when no ItemCorrelations whose corresponding ItemCorrelationType.SubjRoleDesc is “Includes” the selected ItemorCategory as ItemCatIDSubject, display the error message “No more specific levels exist” is shown with an OK button.

Item 88 enables the user to bypass navigating through successive menu levels by partially typing a value here, then selecting on Item 9 to display any matches to what has been typed. Trailing wildcards are assumed-i.e., in the example shown, just typing in “ost,” without any special character as suffix, is enough to bring up “osteoblast,” “osteoclasis,” and all the other values shown.

When Item 89 is selected, Item 85 is populated with only those ItemsorCategories whose Descriptions begin with the characters that have been typed into Item 88. The results are irdered alphabetically.

If button 89 is selected when fewer than three characters have been entered into Item 88, the error message “Please enter at least the first three characters of the content category” is displayed. Item 80 is a display area for the page selected in Item 81.

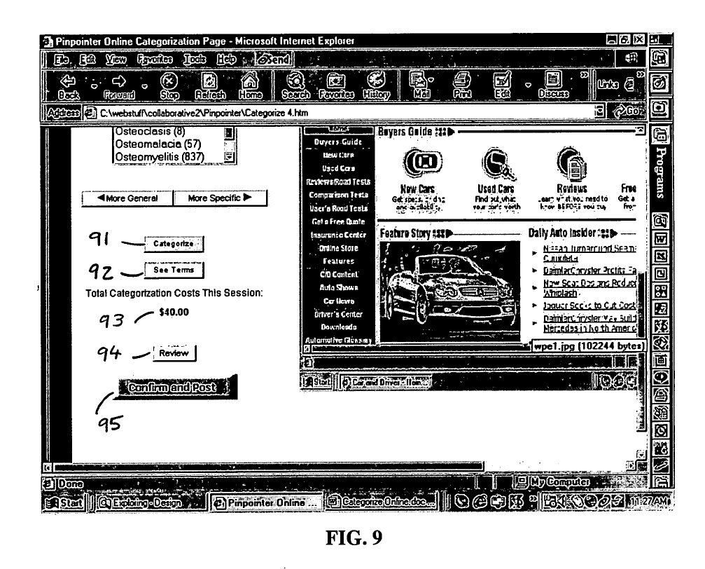

FIG. 9 depicts the bottom half of the exemplary Content Categorization Screen of FIG. 8. When Item 91 is selected, the System begins by validating the home page relationship claimed in Item 4.

First, the System verifies that the URL entered for the home page matches the beginning of the URL of the page being categorized. If it does not, an error panel is generated with the message “Categorized page's URL must have the same beginning as that of its home page” and an OK button.

Next, the System verifies that the URL actually exists. (Issues an unseen call, then tests whether there is a “Page Not Found”-type error.) If the URL does not exist, an error panel with the message “Home page cannot be found” and an OK button is generated.

If the proposed categorization passes both of the tests described above, the System creates an entry for it in pending status in an internal data structure or array. (Note that the “Confirm and Post” button, Item 95, needs to be selected before categorizations are actually applied to the database, and the user is billed.)

When Item 92 is selected, a panel with a simple OK button is generated showing the RuleSpecifiedValues of the BusinessRules corresponding to the ItemorCategory the user has selected whose Descriptions are “Posting Cost” and “Incentive Payment Amount,” respectively. If no ItemorCategory has been selected, generate the error message, “Please select a Content Category” followed by an OK button is produced.

Item 93 displays the sum of the posting costs for all ContentCategorizations currently in pending status (i.e., all for which Item 91 has been selected, but item 95 has not.) Each time Item 91 is selected or categorizations are deleted via the Review Categorizations panel, the sum is refreshed. Posting costs are found in BusinessRules whose ItemCatIdGoverned matches the ItemCatId of the ItemOrCategory used as a categorizer, where BusinessRule.Description=“Posting Cost.” The cost itself is found in RuleSpecifiedValue. (See Appendix A).

When Item 94 is selected, the Review Categorizations sub-screen (described in a subsequent page), is displayed allowing the user to modify or delete categorizations that have not yet been posted to the database.

When Item 95 is selected, the System posts all pending categorizations and bills the appropriate CreditCard for the PersonorOrganization making them. A credit card pre-authorization could be performed before actually posting changes to the database, provided this would not slow processing unacceptably.

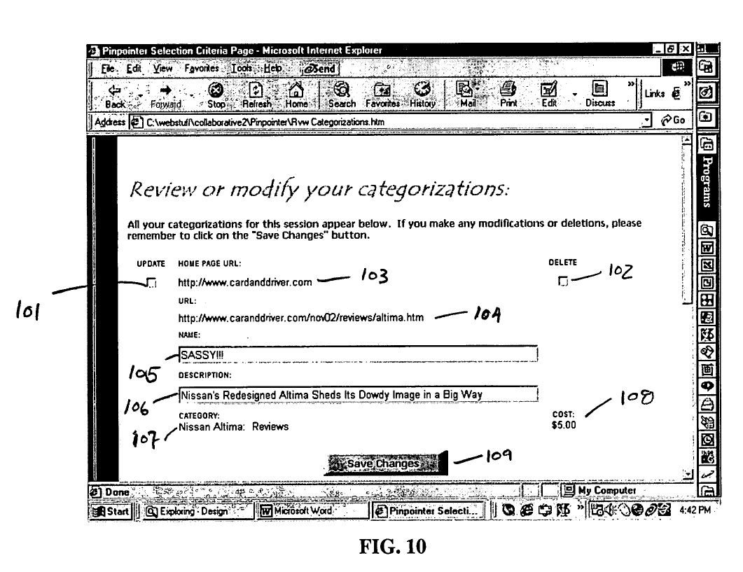

FIG. 10 Illustrates an Exemplary Review Categorizations Sub-Screen. The exemplary screen is generated when the user selects the Review button (Item 94 of the Categorization screen of FIG. 9). This screen enables the user to make last-minute modifications as needed, including deletion of pending categorizations to trim back his total categorization posting cost for the session. Every pending categorization is represented in this manner, with the Save Changes button being presented only once, at the bottom of the page.

Item 101 is only presented when the PersonorOrganization making the categorization has update rights to the content item, i.e., when a ReservedDomain exists whose URLPrefix matches the beginning of the ItemDetail.URL for the ItemorCategory to be categorized, and it shows the PersorgID of the PersonorOrganization making the categorization as its PersorgIDOwner. Selecting this checkbox enables Items 103-106 to be updated.

Item 102 is selected to make a last-minute decision not to post a categorization (typically to reduce costs when Item 93 of the main Content Categorization screen shows a total cost of categorizations above what the user had intended to spend. When Item 109, the Save Changes button, is selected, no categorization with its Delete checkbox checked will actually be posted to the database or charged to the user's credit card.

Item 103 is not updateable in the Review function; it is shown for informational purposes only. Item 104 is not updateable in the Review function; it is shown for informational purposes only. Item 105 is the Name of the ItemorCategory to be categorized. It is only shown in updateable form when the beginning of the URL of the ItemorCategory to be categorized matches the URLPrefix of a ReservedDomain belonging to the Personororganization making the categorization.

Item 106 is the Description of the ItemorCategory to be categorized. It is only shown in updateable form when the beginning of the ItemDetail.URL for the ItemorCategory to be categorized matches the URLPrefix of a ReservedDomain belonging to the Personororganization making the categorization.

Item 107 is the Description of the selected ItemorCategory. This cannot be changed, and is shown for information purposes only. (If the user sees that a mistake has been made, he can delete the categorization and re-enter it more easily and accurately from the main Categorization screen.)

The posting cost of the ItemOrCategory used as a categorizer is shown by Item 108. Posting costs are found in BusinessRules whose ItemCatIdGoverned matches the ItemCatId of the ItemOrCategory used as a categorizer, where BusinessRule.Description=“Posting Cost.” The cost itself is found in RuleSpecifiedValue.

Selecting the Save Changes button (Item 109) applies the modifications made on this screen to the pending categorizations, and returns the user to the main Content Categorization screen with Item 93 (cost) updated to reflect the changes.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the invention as defined by the appended claims.

What is claimed is:

1. A method for identifying content in a computer network, the method comprising:
storing a plurality of predetermined categories in a database;
categorizing a plurality of items corresponding to one or more of the plurality of predetermined categories, by a plurality of categorizers, respectively;
selecting a category from the plurality of predetermined categories;
selecting a categorizer from the plurality of categorizers; and
initiating a search for one or more items in the computer network corresponding to the selected category and the selected categorizer.

2. The method of claim 1, further comprising signing up on a web site as an authorized user.

3. The method of claim 1, further comprising displaying results of the search on a display.

4. The method of claim 3, further comprising ordering the displayed search results based on a user selectable order.

5. The method of claim 1, wherein the step of categorizing comprises signing up on a website as a categorizer and categorizing a plurality of items corresponding to one or more of the plurality of predetermined categories.

6. The method of claim 1, further comprising charging a fee for initiating the search for the one or more items.

7. The method of claim 1, further comprising assigning points to a categorizer based on number of users who have searched an item categorized by the categorizer.

8. The method of claim 7, further comprising compensating the categorizer based on the assigned points.

9. The method of claim 7, further comprising positioning the categorizer on a favorable screen position of a display screen, based on the assigned points to the categorizer.

10. The method of claim 1, further comprising displaying a list of categorizers on a display screen.

11. The method of claim 10, wherein the list of categorizers displayed on the display screen is ordered based on one or more of a respective categorizer's overall popularity within the selected category, a respective categorizer's recent popularity within the selected category, a respective categorizer's overall popularity within a broader subject area than the selected category, a respective categorizer's recent popularity within a broader subject area than the selected category, a respective categorizer's reliability within a user-specified subject area, and a respective categorizer's reliability within a broad subject area.

12. The method of claim 1, wherein at least one of the plurality of predetermined categories relates to music.

13. The method of claim 1, wherein at least one of the plurality of predetermined categories relates to movies.

14. The method of claim 1, wherein at least one of the plurality of predetermined categories relates to books.

15. The method of claim 1, wherein at least one of the plurality of predetermined categories relates to web pages.

16. The method of claim 1, wherein at least one of the plurality of predetermined categories relates to security or intelligence content.

17. The method of claim 1, wherein at least one of the plurality of predetermined categories relates to a product or a service.

18. The method of claim 17, wherein the product or the service is one or more of art, craft, wine, cheese, beer, plumbing, air conditioning, auto repair, haircutting, legal service, and medical service.

19. A method for categorizing an item to be searched by a user in a computer network, the method comprising:
accessing a web site by an authorized categorizer;
identifying the item to be categorized;
selecting a category from a plurality of predetermined categories stored in a database accessible by the web site;
applying the selected category to the identified item; and
storing the identified item and the applied category in the database.

20. The method of claim 19, further comprising signing up on a web site as an authorized user.

21. The method of claim 20, further comprising
selecting a category from a plurality of predetermined categories;
selecting a categorizer from a plurality of categorizers; and
initiating a search for an item in the computer network corresponding to the selected category and the selected categorizer.

22. The method of claim 21, further comprising displaying results of the search on a display.

23. The method of claim 22, further comprising ordering the displayed search results based on a user selectable order.

24. The method of claim 19, further comprising charging the categorizer a fee for categorizing the item.

25. The method of claim 21, further comprising assigning points to a second categorizer based on number of users who have searched an item categorized by the second categorizer.

26. The method of claim 25, further comprising compensating the second categorizer based on the assigned points.

27. The method of claim 25, further comprising positioning the second categorizer on a favorable screen position of a display screen, based on the assigned points to the second categorizer.

28. A system for identifying content in a computer network comprising:
means for storing a plurality of predetermined categories;
means for categorizing a plurality of items corresponding to one or more of the plurality of predetermined categories, by a plurality of categorizers, respectively;
means for selecting a category from the plurality of predetermined categories;
means for selecting a categorizer from the plurality of categorizers; and
means for initiating a search for one or more items in the computer network corresponding to the selected category and the selected categorizer.

29. The system of claim 28, further comprising means for signing up on a web site as an authorized user.

30. The system of claim 28, further comprising displaying results of the search on a display.

31. The system of claim 30, further comprising means for ordering the displayed search results based on a user selectable order.

32. The system of claim 28, wherein means for categorizing comprises means for signing up on a website as a categorizer and means for categorizing a plurality of items corresponding to one or more of the plurality of predetermined categories.

33. The system of claim 28, further comprising means for charging a fee for initiating the search for the one or more items.

34. The system of claim 28, further comprising means for assigning points to a categorizer based on number of users who have searched an item categorized by the categorizer.

35. The system of claim 34, further comprising means for compensating the categorizer based on the assigned points.

36. The system of claim 28, further comprising means for positioning the categorizer on a favorable screen position of a display screen, based on the assigned points to the categorizer.

37. The system of claim 28, wherein at least one of the plurality of predetermined categories relates to a product or a service.

38. A system for categorizing an item to be searched by a user in a computer network comprising:
means for accessing a web site by an authorized categorizer;
means for identifying the item to be categorized;
means for selecting a category from a plurality of predetermined categories stored in a database accessible by the web site;
means for applying the selected category to the identified item; and
means for storing the identified item and the applied category in the database.

39. The system of claim 38, further comprising means for signing up on a web site as an authorized user.

40. The method of claim 39, further comprising
means for selecting a category from a plurality of predetermined categories;
means for selecting a categorizer from a plurality of categorizers; and
means for initiating a search for an item in the computer network corresponding to the selected category and the selected categorizer.
